(19) United States
(12) Patent Application Publication
(10) Pub. No.: US 2003/0147077 A1
(43) Pub. Date: Aug. 7, 2003

(54) Mask alignment method

(75) Inventors: Enio L. Carpi, Fishkill, NY (US); Bernhard Liegl, Cold Spring, NY (US); Peter Thwaite, Beacon, NY (US)

Correspondence Address: F. CHAU & ASSOCIATES, LLP, Suite 501, 1900 Hempstead Turnpike, East Meadow, NY, 11554, US

(73) Assignee: Infineon Technologies North America Corp.

(21) Appl. No.: 10/067,703

(22) Filed: Feb. 5, 2002

(51) Int. Cl. G01B 11/00

(52) U.S. Cl. 356/401

(57) ABSTRACT

Disclosed is a method of aligning a mask with a semiconductor wafer surface, comprising the steps of providing a semiconductor surface with one or more wafer alignment marks thereon, providing a mask with one or more etchings effective in generating one or more 0-π-phase-conflict alignment marks under ambient lighting conditions of use, wherein each said wafer alignment mark is of a geometry that is compatibly aligning with a corresponding 0-π-phase-conflict alignment mark, and aligning said 0-π-phase-conflict alignment marks with their corresponding wafer alignment marks.

### FIELD OF THE INVENTION

This invention relates to alignment marks for aligning masks with semiconductor wafers.

### BACKGROUND OF THE INVENTION

Current alignment techniques in the field of lithography often suffer poor signal-to-noise ratios due to variation in the film stack that forms the alignment mark. Hence, errors in manufacturing arise because the operator cannot always properly align the etching mask with the underlying wafer. What is needed is a mask alignment mark that does not rely on a film and consistently provides high signal-to-noise ratio under ambient lighting conditions.

### SUMMARY OF THE INVENTION

Disclosed is a method of aligning a mask with a semiconductor wafer surface, comprising the steps of providing a semiconductor surface with one or more wafer alignment marks thereon, providing a mask with one or more etchings effective in generating one or more 0-π-phase-conflict alignment marks under ambient lighting conditions of use, wherein each said wafer alignment mark is of a geometry that is compatibly aligning with a corresponding 0-π-phase-conflict alignment mark, and aligning said 0-π-phase-conflict alignment marks with their corresponding wafer alignment marks.

In another aspect of the method said ambient lighting conditions comprise an illumination wavelength of from about 150 to about 450 nanometers.

In another aspect of the method said wavelength is about 193 nanometers.

In another aspect of the method said one or more etchings comprise a depression about 48 nanometers in depth.

Disclosed is a 0-π-phase conflict mask, comprising a mask comprising a transparent base material, having at least one depression etched thereon, said depression effective in generating a 0-π-phase-conflict mark under ambient lighting conditions of use.

In another aspect of the apparatus said ambient lighting conditions comprise a wavelength of from about 150 to about 450 nanometers.

In another aspect of the apparatus said lighting conditions comprise a wavelength of about 193 nanometers and said depression is about 48 nanometers deep.

In another aspect of the apparatus said transparent material comprises quartz.

Disclosed is a method of making a semiconductor manufacturing mask, comprising the steps of providing a transparent base material, providing said base material with an attenuating layer, patterning said attenuating layer with a resist layer, said resist layer patterned to expose a portion of said base material, and etching, at said exposed portion, a depression to a depth effective in generating a 0-π-phase conflict mark under ambient lighting conditions of use, said mark positioned to align with a corresponding mark on a semiconductor wafer.

In another aspect of the apparatus said ambient lighting conditions comprise an illumination wavelength of from about 150 to about 450 nanometers.

In another aspect of the apparatus said wavelength is about 193 nanometers.

In another aspect of the apparatus said depression is about 48 nanometers in depth.

In another aspect of the apparatus said transparent material is quartz.

### BRIEF DESCRIPTION OF THE DRAWINGS

FIG. 1 shows a 0-π-phase-conflict alignment mark.

FIG. 2 shows the 0-π-phase-conflict alignment mark of FIG. 1 superimposed and aligned with a wafer alignment mark.

FIG. 3 shows a method of making a 0-π-phase-conflict alignment mark.

FIG. 4 shows the use of a 0-π-phase-conflict alignment mark in the manufacture of a semiconductor.

### DETAILED DESCRIPTION OF PREFERRED EMBODIMENTS

A 0-π phase conflict arranged on certain layouts at the mask level generates a very bright box from reflected light. Due to the high contrast, a high signal-to-noise ratio is achieved. Because the structure on the wafer may be a simple box frame, a simplified layout may be designed. The box frame may also be optimized to minimize the impact of film stack variations.

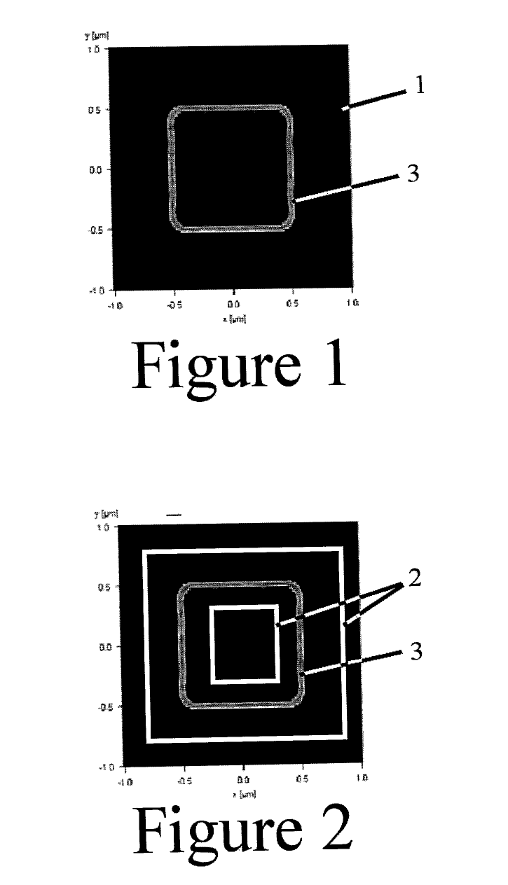

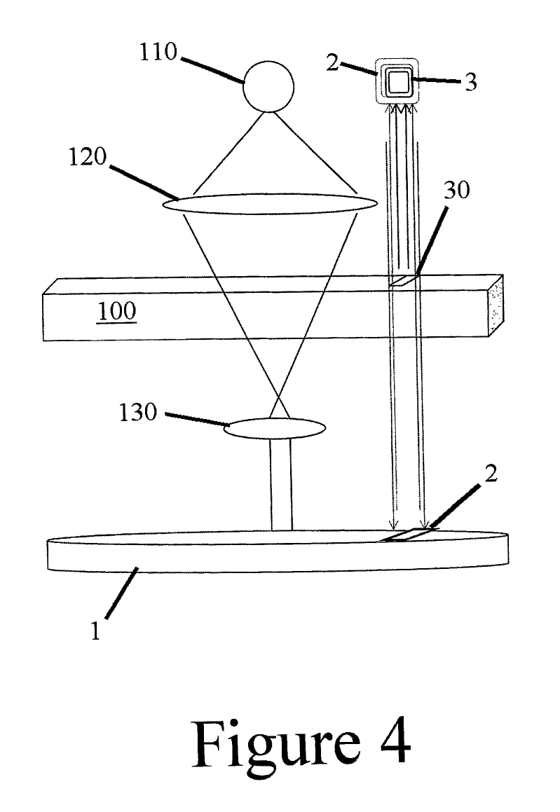

Referring to FIG. 1, there is shown an image having one bright frame-shaped mark 3 originated from a convenient mask layout with 0-π-phase-conflict under adequate lighting conditions. Because the mask 100 is transparent at the location of the mark, the black background is the wafer 1 itself, as seen through the transparent mask 100 (see FIG. 4). Generally, masking operations are typically carried out under light in the ultra-violet part of the spectrum, which would correspond to wavelengths of about 0.15 to about 0.4 micrometers (i.e., 150 to 450 nanometers), preferably about 0.193 micrometers.

The width of the bright shape depends on the illumination conditions and wavelength. As the system relies on a through-the-lens illumination and detection, the same wavelength used for resist exposure is used for imaging. For typical illumination conditions (e.g., numerical aperture (NA)=0.68, coherence factor (σ)=0.3, and illumination wavelength (λ)=193 nm) the width of the bright line on the frame is about 240 nm.

The result of the 0-π phase conflict is that a bright shape appears under illumination. The shape used in the drawings is a box, though it may be any shape effective to the purpose. Boxes and crosses are preferred shapes for alignment purposes, having both vertical and horizontal elements. An advantage of using phase conflict to generate an image is that the image is independent of any film stack variations such as are known to affect the performance of traditional marks.

Referring to FIG. 2, there are provided one or more wafer alignment marks 2, each comprising a compatibly aligning geometry to the shapes of its corresponding 0-π-phase-conflict alignment mark 3 on the mask 100, meaning that the shapes of the 0-π phase mask alignment mark 3 may be aligned or fitted with the shapes of the wafer alignment marks 2 when superimposed. The simplest way would be to have the alignment marks of substantially identical shape or size, though exact shape and size is not required. As can be seen in the drawing, the mask alignment mark 3 is comprised of one or more edges 3 of substantially the same shape, but different size, as those of the wafer alignment mark 2, but not quite identical, the mask 0-π-phase-conflict alignment mark 3 having rounded comers and being small enough to just fit concentrically within the wafer alignment mark 2.

The wafer alignment mark 2 is etched into the wafer 1 (not shown here, see FIG. 4) and may utilize nanoscale features to enhance contrast and visibility, such as is described in copending commonly assigned application METHOD OF ENHANCING ALIGNMENT MARKS, Attorney Docket No. 8055-104, the disclosures of which are incorporated by reference herein in their entirety.

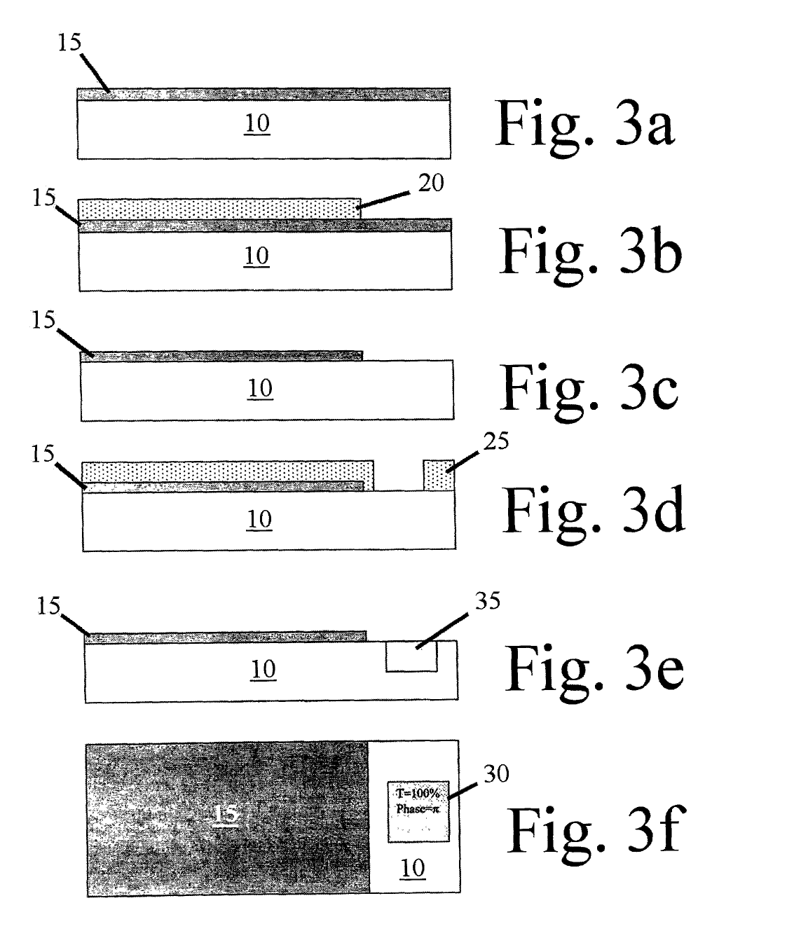

Referring to FIGS. 3a through 3f, there is shown a process by which the 0-π-phase-conflict marks of the invention may be made upon a mask 100. A transparent mask base 10, usually quartz, is provided with an attenuating layer 15, such as a chrome layer. As seen in FIG. 3b, a resist layer 20 is patterned atop this structure and the attenuating layer 15 is thereby etched away (FIG. 3c) to expose a small portion of the transparent base 10. Another resist layer 25 is patterned (FIG. 3d) to cut a shape into the quartz, the edges of the shape corresponding with the edges of the mask mark, and a depression 35 is etched (FIG. 3e) into the base 10 down to a depth effective in providing the 0-π-phase-conflict effect that is desired.

The depth depends on the phase target, the wavelength used for illumination, and the refractive index of the base. It will be about 48 nm deep for a 0-π-phase at 193 nm illumination wavelength. It is preferred that the etch be conducted so as to leave the bottom of the depression 35 flat and transparent so that any wafer marks beneath it remain visible. Both wet etches or dry etches may be used for this purpose. A preferred method is to first dry etch the depression 35 and then follow with a quick wet etch to remove surface roughness.

FIG. 3f is a top plan view of FIG. 3e. When illuminated, the sharp edge 30 of the depression induces a 0-π-phase-conflict and produces a brightly lit pattern of the same size and shape of the rim 30.

FIG. 4 shows how the mask 100 with the 0-π-phase-conflict mark edge 30 is used in semiconductor manufacture. A light source 110 is provided, the illumination from which is generally shone through a light condenser 120 and through the mask 100. A reduction lens 130 shrinks the resultant mask image and focuses it upon the wafer 1. The objective is to align the wafer mark 2 (in this example, a single rectangle as opposed to the double rectangle of FIG. 2) with the 0-π-phase-conflict image 3 created by light reflecting off the edges 30 of the depression formed on the mask 100. A viewport located above the mask (not shown) allows the operator to look down through the mask 100 to the wafer mark 2 on the wafer below and may thereby fine tune the position of the wafer using positioning means well known in the art.

It is to be understood that all physical quantities disclosed herein, unless explicitly indicated otherwise, are not to be construed as exactly equal to the quantity disclosed, but rather as about equal to the quantity disclosed. Further, the mere absence of a qualifier such as “about” or the like, is not to be construed as an explicit indication that any such disclosed physical quantity is an exact quantity, irrespective of whether such qualifiers are used with respect to any other physical quantities disclosed herein.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

What is claimed is:

1. A method of aligning a mask with a semiconductor wafer surface, comprising the steps of:
providing a semiconductor surface with one or more wafer alignment marks thereon;
providing a mask with one or more etchings effective in generating one or more 0-π-phase-conflict alignment marks under ambient lighting conditions of use;
wherein each said wafer alignment mark is of a geometry that is compatibly aligning with a corresponding 0-π-phase-conflict alignment mark; and
aligning said 0-π-phase-conflict alignment marks with their corresponding wafer alignment marks.

2. The method of claim 1 wherein said ambient lighting conditions comprise an illumination wavelength of from about 150 to about 450 nanometers.

3. The method of claim 2 wherein said wavelength is about 193 nanometers.

4. The method of claim 3 wherein said one or more etchings comprise a depression about 48 nanometers in depth.

5. A 0-π-phase conflict mask, comprising:
a mask comprising a transparent base material, having at least one depression etched thereon, said depression effective in generating a 0-π-phase-conflict mark under ambient lighting conditions of use.

6. The mask of claim 5 wherein said ambient lighting conditions comprise a wavelength of from about 150 to about 450 nanometers.

7. The mask of claim 6 wherein said lighting conditions comprise a wavelength of about 193 nanometers and said depression is about 48 nanometers deep.

8. The mask of claim 5 wherein said transparent material comprises quartz.

9. A method of making a semiconductor manufacturing mask, comprising the steps of:
providing a transparent base material;
providing said base material with an attenuating layer;
patterning said attenuating layer with a resist layer, said resist layer patterned to expose a portion of said base material; and
etching, at said exposed portion, a depression to a depth effective in generating a 0-π-phase-conflict mark under ambient lighting conditions of use, said mark positioned to align with a corresponding mark on a semiconductor wafer.

10. The method of claim 9 wherein said ambient lighting conditions comprise an illumination wavelength of from about 150 to about 450 nanometers.

11. The method of claim 10 wherein said wavelength is about 193 nanometers.

12. The method of claim 11 wherein said depression is about 48 nanometers in depth.

13. The method of claim 9 wherein said transparent material is quartz.
